(19) United States
(12) Patent Application Publication
(10) Pub. No.: US 2002/0046196 A1
(43) Pub. Date: Apr. 18, 2002

(54) Postage indicium fraud detection method

(76) Inventor: Craig L. Ogg, Long Beach, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/938,117

(22) Filed: Aug. 23, 2001

Related U.S. Application Data
(60) Provisional application No. 60/227,854, filed on Aug. 23, 2000.

(51) Int. Cl. G06F 17/00; G07B 17/02; B65B 35/00; G06F 9/00

(52) U.S. Cl. 705/406

(57) ABSTRACT

A postage indicium fraud detection method for permitting the automated processing of void mail pieces bearing a unique postage indicium using existing automated mail handling equipment. The method includes printing a unique indicium on a mail piece or a label to be applied to a mail piece, which indicium is adapted to be identified and sorted by automated mail handling equipment and which unique indicium identifies the mail piece as being a void mail piece. The unique indicium can be a new type of FIM mark, a POSTNET barcode, or other indicium. The void mail piece bearing the unique indicium with the automated mail handling equipment is processed to identify and segregate the void mail piece from other non-void mail pieces.

### CROSS REFERENCE TO RELATED APPLICATIONS

This application claims priority of provisional patent application No. 60/227,854, filed on Aug. 23, 2000.

### FIELD OF THE INVENTION

This invention is related generally to the field of PC postage, and more particularly to a method of printing PC postage indicium and a unique PC postage indicium that helps thwart postal fraud.

### BACKGROUND OF THE INVENTION

The United States Postal Service (USPS) has recently implemented the Information Based Indicia Program (IBIP) to create electronic access to postage for postal service users. An integral part of the IBIP is Information Based Indicia (IBI), which like meter impressions, is printed on an envelope in the upper right-hand corner, or on a label for attachment to an envelope or package. PC Postage™ refers to products for postage purchase and printing from a computer using standard ink jet, laser jet, and other such high resolution printers that are developed by commercial providers and approved by the U.S. Postal Service using IBI. The IBI conveys evidence that postage has been paid and contains mail processing data requirements. The indicia are made up of human readable information as well as a two-dimensional barcode.

The human readable portion includes the postage value, the mail class, the date, the meter number, and optionally a logo and/or a Facing Identification Marking (FIM). The destination zip code is required for business courtesy mail pieces, but is optional for other types of mail pieces. The 2-D barcode portion includes: date of mailing, destination delivery point, postage, software ID, digital signature, ascending register, rate category, descending register, reserve field, algorithm ID, indicia version number, and certificate serial number. The licensing post office/mailed from ZIP code and device ID are also printed in a human readable form below the 2-D barcode. A FIM is frequently printed above the 2-D barcode and to the left of the human readable rate category along with the other portions of the PC Postage.

In order to permit the sophisticated mail handling and optical reading equipment at the USPS to properly interpret the PC Postage and addressee information, it is critical that the postage indicia be applied properly. The USPS has established strict guidelines directed to the margins, label sizes, and placement of the Postage Indicia, and the size, placement, and other characteristics of the POSTNET (POStal Numeric Encoding Technique) bar codes, and any facing identification mark (FIM) on mail pieces. These guidelines are contained in the Domestic Mail Manual (DMM) and Title 39, Code of Federal Register (CFR), Part 111, and USPS Publication No. 25 “Designing Letter Mail”.

During the preparation of PC Postage, it is desirable to give the user the option to either display a “print preview” of PC Postage, or actually print out a sample of the PC Postage to confirm that all information is correct. However, a user could potentially use a “print screen” feature of the computer's software to print out extra labels without the appropriate postage value being charged to the user, resulting in the possibility of fraud being perpetrated on the USPS and the commercial provider. Thus, the client software provided by PC postage providers to their users will preferably display the words “VOID”, “SAMPLE” or some similar message to warn the user that the PC postage being display or printed is not intended for mailing. As noted above, the USPS relies to a great extent on sophisticated mail handling and optical reading equipment to sort mail. However, this mail sorting equipment is not set up to inspect and authorize 100% of the mail being processed, or in the case of PC Postage, whether the PC Postage affixed to the mail piece is legitimate or if it is voided in some manner. Instead, statistical sampling of mail pieces bearing PC Postage is utilized to detect and determine the rate of fraud.

It would be highly useful if there were a fully automated method of fraud detection and prevention that could be used with existing mail handling and optical reading equipment, which method could be used to detect and divert mail pieces bearing voided PC Postage.

### SUMMARY OF THE INVENTION

The invention uses a new FIM pattern, a so-called “FIM E” to automatically identify voided indicia mail pieces. The FIM E will have a line pattern distinct from that of FIM A, FIM B, and FIM C, but will otherwise have the same relative size, appearance, and placement on a mail piece. The client software will display and print a FIM E pattern whenever a user displays or prints a sample PC Postage indicia. The existing mail handling equipment and optical character scanning equipment at the USPS, which can positively identify all mail pieces with FIM patterns and separate them accordingly from non-FIM pattern marked mail pieces, can be easily programmed to identify FIM E patterns and to segregate all FIM E bearing mail pieces (which will correspond to all mail pieces with voided indicia.) The USPS can then return the rejected mail piece to the sender for postage due, issue a warning to the user not to use voided PC postage, and/or handle the mail pieces in some other appropriate manner.

In addition to or in lieu of use of a FIM E, the client software can print a unique POSTNET barcode onto the sample mail piece. The client software will display and print a unique ZIP or preferably ZIP+4 barcode (“Void ZIP barcode”) that does not correspond to an actual ZIP or ZIP+4 code, but instead identifies the mail piece as being one bearing a voided indicia. The USPS sorting machinery can be programmed to recognize this as corresponding to a Void POSTNET or ZIP barcode. The existing mail handling equipment optical character scanning equipment at the USPS will identify the Void ZIP barcode, and will positively identify all mail pieces with the Void ZIP barcode and segregates them from non-void ZIP barcode identified mail pieces at the USPS. The USPS can then return them to the sender for postage due, issue a warning to the user not to use voided indicia, and/or handle the mail pieces in some other appropriate manner.

While the term USPS, and particular types of FIM designations are described herein, the invention is applicable to the postage handling systems and methods of postage systems of other countries, many of which use FIM types of indicia, POSTNET types of coding, and/or other detail-rich kinds of coding to provide for automated handling of mail pieces.

### BRIEF DESCRIPTION OF THE DRAWINGS

FIG. 1 is a view of a “Print Postage” screen print of representative client server software.

FIG. 2 is a “Modified Address” screen print of representative client server software.

FIG. 3 is a “Print Sample Envelope” screen print of representative client server software.

FIG. 4 is a sample envelope printed with the representative client server software, displaying the “VOID” message, but with conventional FIM markings and conventional POSTNET barcode data corresponding the addressee's ZIP code.

FIG. 5 is a sample custom sized envelope printed with the representative client server software, displaying the “VOID” message, but with conventional FIM markings and conventional POSTNET barcode data corresponding the addressee's ZIP code.

FIG. 6A is a conventional FIM A pattern.

FIG. 6B is a conventional FIM B pattern.

FIG. 6C is a conventional FIM C pattern.

FIG. 6D is an embodiment of a FIM E pattern of the invention.

FIG. 7 is a sample envelope printed with the representative client server software, displaying the “VOID” message, and also with FIM E marking of the invention and Void ZIP POSTNET barcode data that does not correspond to the addressee's ZIP code.

FIG. 8 is a flowchart showing the method of the invention.

### DETAILED DESCRIPTION OF THE INVENTION

In order to print PC Postage, for example, going through a provider such as Stamps.com, the user first installs the provider's software (“Client Software”). The printer that will print the postage onto labels or envelopes must be selected/configured. During the installation process of the client software, the user is guided through a printer configuration process using a pattern test. Once the printer has been successfully configured, the user is directed to print a sample envelope. The sample envelope confirms the correct configuration of the printer and assures the user that the printer will correctly print envelopes. If the sample envelope is printed without errors, then the user is ready to begin printing envelopes with actual postage.

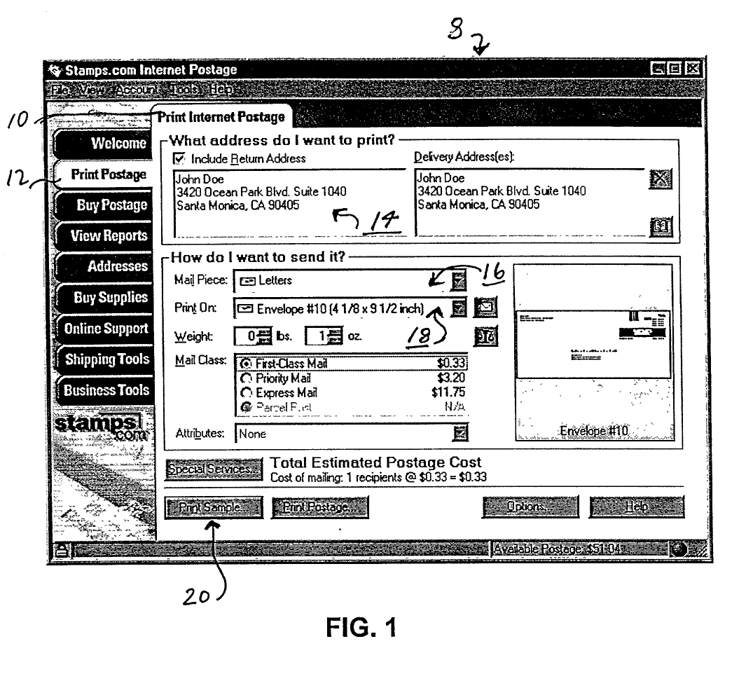

FIG. 1 is a view of a “Print Postage” screen print 8 of representative client server software. After the client has finished configuring the printer, the Print Postage window 10 appears. Alternately, the user may select the “Print Postage” tab 12 from the options on the left side of the main client window 8. To print a sample envelope from the Print Postage window, for example, the user:

1. enters a valid delivery address 14;

2. selects “Letter” in the Mail Piece drop-down box 16;

3. selects “Envelope” in the Print On drop-down box 18; and

4. clicks “Print Sample” 20.

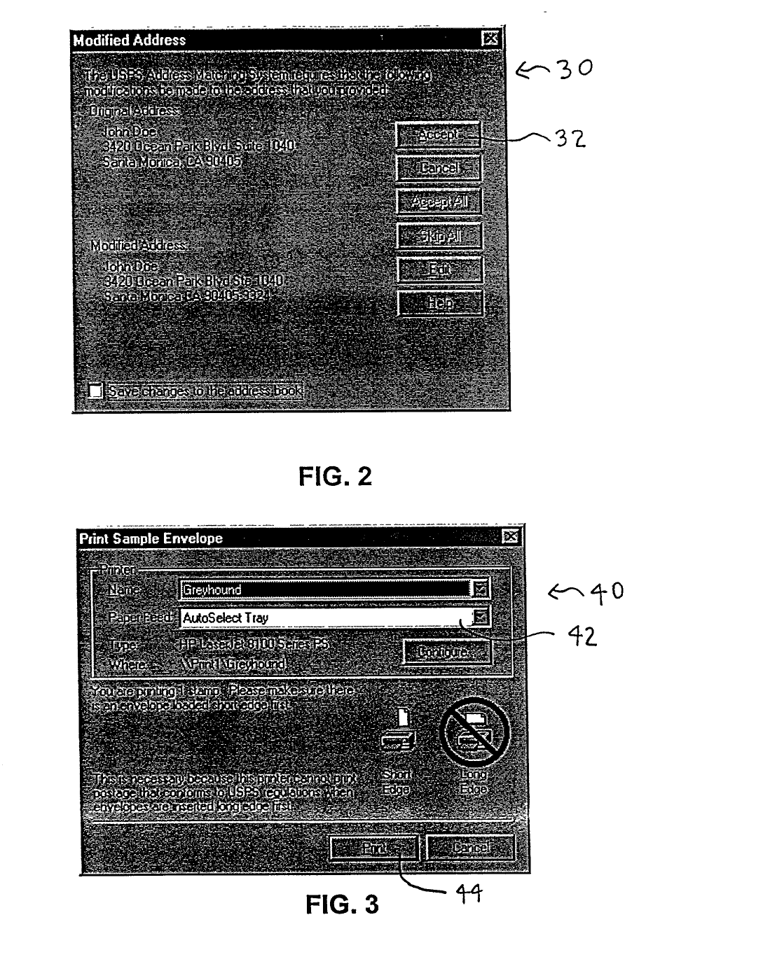

Turning to FIG. 2, if a user is printing a sample mail piece, thereafter, the client verifies the delivery address and displays the Modified Address window 30. This window adds or changes details pertaining to the delivery address as required by the United States Postal Service, e.g., to convert a 5-digit zip code to a 9-digit zip code. If the new address is correct, the user clicks “Accept” 32.

The Print Sample Envelope window appears 40, as shown in FIG. 3. At this point, the user selects the appropriate Paper Feed 42, places a selected envelope in the envelope feeder of the printer (not shown) and clicks “Print” 44.

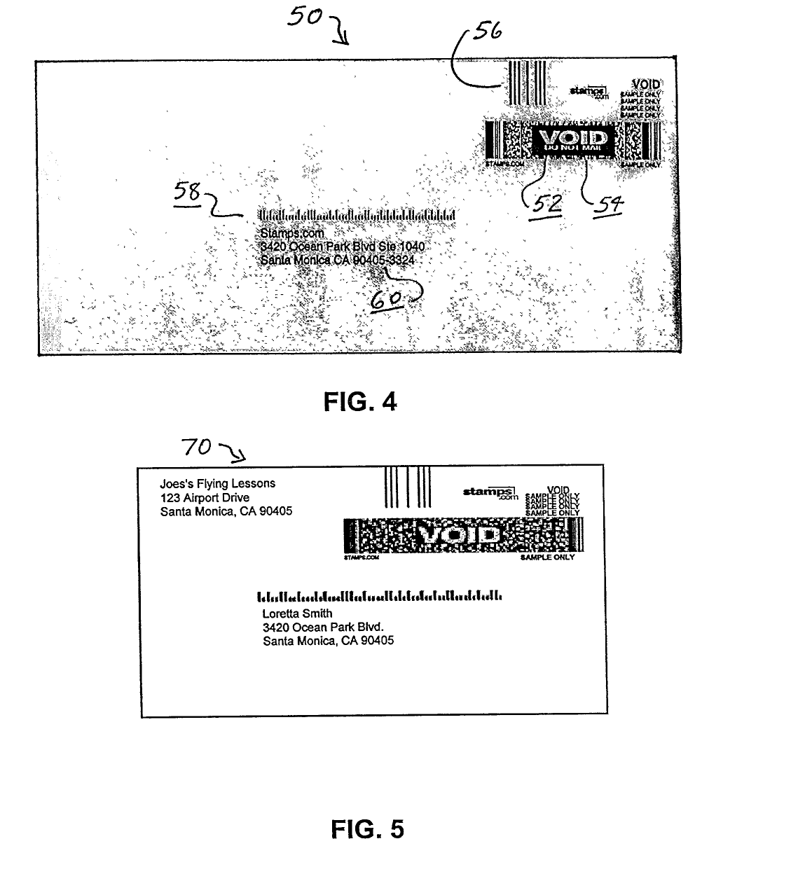

Shown in FIG. 4 is a sample envelope 50 printed by the Client Software, which has the words “VOID DO NOT MAIL” 52 on the 2-D barcode portion 54. The sample envelope 50 has a conventional FIM markings 56 and conventional POSTNET barcode data 58 corresponding the addressee's ZIP code 60.

There are several reasons to allow a user to print a sample envelope. One important reason is to ensure that the printer is printing the envelope in the correct direction and is printing the addresses on the front of the envelope. For instance, the FIM mark must be on the top of the envelope and the delivery address must be printed in the center front of the envelope with the POSTNET bar code. Also, when users are printing new self-adhesive labels (not shown), they must ensure that the indicia, addressee label, and optionally sender labels are being properly printed. In some cases, the user may have to change the placement of the envelope in the feed tray to facilitate printing. The printing sample envelope feature allows the user to print as many envelopes as necessary to test the printer, without using paid postage. The sample envelope feature can be used at any time. For example, if the user uses a different printer and/or computer to print postage from his/her/its account, the user may need to configure another printer and test the envelopes for that particular printer. Likewise, if a user purchases a new printer and configures it, the user must test the new printer as well.

Frequently, users have occasion to print custom envelopes that have different sizes and characteristics from normal envelopes, for example, the custom size envelope 70 as shown in FIG. 5. The print Sample Envelope feature is also used is in conjunction with the Custom Envelope feature of the Client Software. When the user creates a new envelope size, an important step before using the new size is testing the envelope to ensure that the PC Postage prints correctly on the new envelope. As the user uses, for example, a “Custom Envelope Wizard” (not shown), the user is prompted to print a sample envelope. Again, the sample envelope is used to verify that the printer can print the envelope according to the required specifications. When the user prints a sample envelope, the user obviously should not be forced to use real postage. Therefore, it is necessary to support a sample envelope using a void indicium.

The USPS is in need of improved methods to prevent users from using void PC postage to send out their mail pieces, and to permit the USPS to effectively detect and intersect void PC Postage mail pieces.

The invention solves the problem of voided indicia being mailed and processed by applying a special FIM mark and/or POSTNET barcode representing a special value to direct all mail pieces with void indicia to a separate handling location at the USPS designated to process void indicia. Since the USPS currently has a system to read FIM marks and POSTNET barcodes, it is relatively simple for the USPS to support Internet postage vendors that print a special FIM mark and/or POSTNET barcode for sample envelopes using void indicia. As noted above, while the method and system is described in connection with the USPS, FIM marks and POSTNET barcodes, the method and system of the invention is equally applicable to the automated mail handling system of countries other than the U.S.

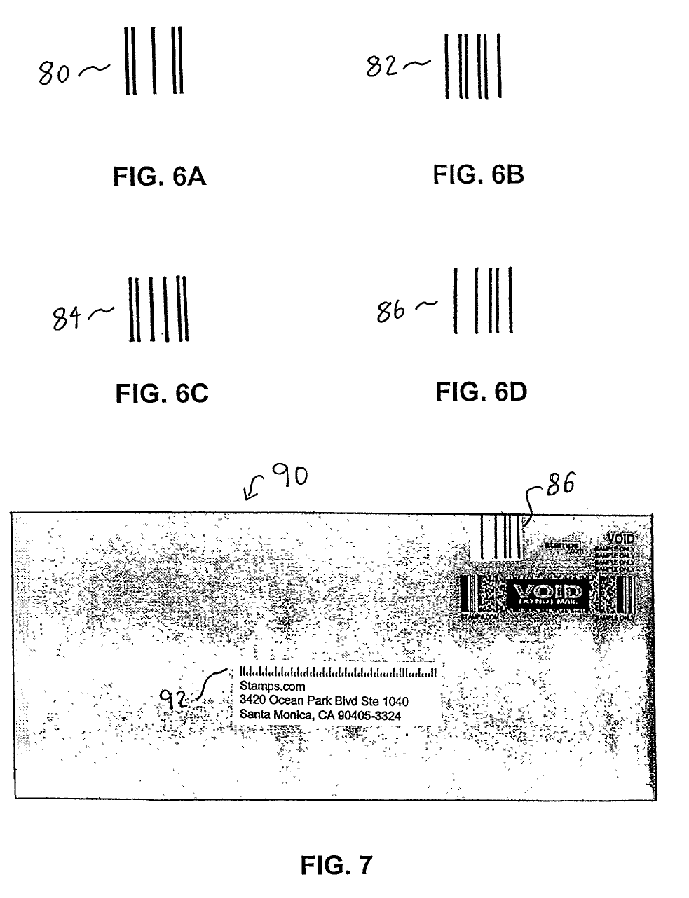

Turning to FIGS. 6A, 6B, 6C, and 6D, there are shown FIM A 80, FIM B 82, FIM C 84, and a new FIM E 86, respectively. FIM A 80 is used for courtesy reply mail (CRM) and meter reply mail (MRM) typically provided as enclosures in automated rate mailings with a preprinted barcode. FIM B 82 is used for business reply mail (BRM) without a preprinted BRM ZIP+4 barcode. FIM C 84 is used for BRM with a preprinted BRM ZIP+4 barcode. FIM A 80, FIM B 82, and FIM C 84 are presently existing FIM patterns. Further information concerning FIM patterns is found in the Domestic Mail Manual (DMM), Issue 54, Jan. 10, 1999, and Title 39, Code of Federal Register (CFR), Part 111, and USPS Publication No. 25 “Designing Letter Mail”. The invention uses a new FIM pattern, which the inventors name FIM E 86, and is used to identify voided indicia mail pieces. It will have a line pattern distinct from that of FIM A, FIM B, and FIM C, but will otherwise have the same relative size, appearance, and placement on a mail piece. FIM E of FIG. 6D is just one of many possible line patterns and is shown for sake of representation. The Client Software will display and print a FIM E 86 pattern whenever a user displays or prints a sample PC Postage indicia. The existing mail handling equipment and optical character scanning equipment at the USPS, which can positively identify all mail pieces with FIM patterns and separate them accordingly from non-FIM pattern marked mail pieces, can be easily programmed to identify FIM E patterns and to segregate all FIM E bearing mail pieces (which will correspond to all mail pieces with voided indicia.) The USPS can then return the rejected mail piece to the sender for postage due, issue a warning to the user not to use voided PC postage, and/or handle the mail pieces in some other appropriate manner.

FIG. 7 shows a sample envelope 90 printed with a FIM E 86. The FIM E 86 will be printed exactly where the other types of FIM patterns would appear on the envelope 90, so will be reliably detected by the USPS mail handling equipment. In addition to or in lieu of use of a FIM E 86, the client software can print a unique POSTNET barcode 92 onto the sample mail piece 90. A POSTNET barcode is used to sort mail by automated machines. A 5-digit barcode is a single field of 32 bars consisting of one frame bar, a series of 25 bars that represents the correct 5-digit ZIP code for the address of the mail piece, 5 bars that represent the correction digit, and a final frame bar. A ZIP+4 barcode is a single field of 52 bars consisting of a frame bar, a series of 45 bars that represents the correct ZIP+4 barcode for the address of the mail piece, 5 bars that represent the correction digit, and a final frame bar. A tall bar represents a “1”, and a short bar represents a “0”. Using the appropriate pattern of long and short bars, the addressee's ZIP or ZIP+4 code can thus be encoded in a manner that is easily and reliably sorted by automated mailing handling equipment at the USPS. The client software will display and print a unique ZIP or preferably ZIP+4 barcode (“Void ZIP barcode”) that does not correspond to an actual ZIP or ZIP+4 code, but instead identifies the mail piece as being one bearing a voided indicia. In fact, this Void ZIP barcode will override the POSTNET barcode that corresponds to the addressee. In the example of FIG. 7, the Void ZIP barcode 92 codes for 99999-9999. However, any available and convenient code could be selected. The USPS sorting machinery can be programmed to recognize this as corresponding to a Void ZIP barcode. The existing mail handling equipment optical character scanning equipment at the USPS will identify the Void ZIP barcode, and will positively identify all mail pieces with the Void ZIP barcode and segregates them from non-Void ZIP barcode identified mail pieces at the USPS. The USPS can then return them to the sender for postage due, issue a warning to the user not to use voided indicia, and/or handle the mail pieces in some other appropriate manner. FIG. 7 shows a mail piece bearing a sample Void Zip barcode, as well as a FIM E. As noted above, one or both can be utilized.

The Client Software can optionally display a PLANET code in addition to or in lieu of a Void ZIP barcode. A PLANET Code (PostaL Alpha Numeric Encoding Technology) is similar to a POSTNET code, but uses short bars to represent “1” and long bars to represent “0”. PLANET codes are read by the USPS equipment. Like POSTNET codes, PLANET codes are scanned by the USPS equipment. However, unlike POSTNET codes which are used to sort mail, PLANET codes are used to identify the sender of the mail piece. When the mail piece is processed by the USPS, the date and time of processing is electronically delivered to the addressee, and is useful if the mail piece contains, for example, a check or order form.

In another embodiment of the invention, the PLANET code can also be added to the mail piece by server software. Armed with the both the FIM E and/or Void ZIP barcode and the PLANET code, the USPS can automatically collect data as to exactly when a Voided PC Postage mail piece was attempted to be processed, and who was the sender. This can further reduce human intensive manual processing.

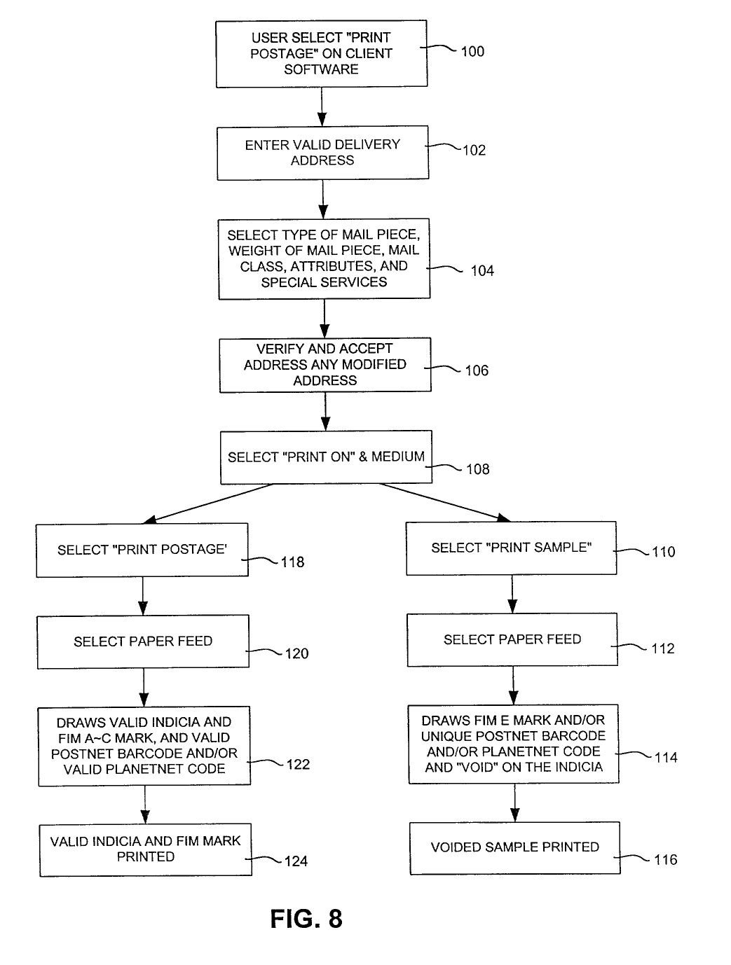

Turning to FIG. 8, a flowchart of the method of the invention is shown. In a first step 100, a user selects “Print Postage” on Client Software. Next, the user enters a valid delivery address 102, and then selects type of mail piece, weight of mail piece, mail class, attributes, and special services 104. The user will then verify and accept address a possible modified address 106. Next, the user will be asked to select a print on medium button 108, which will be all the user to either print a sample or actual mail piece. If the user chooses to print a sample, the user will select a print sample button 110 and will then select a paper feed 114 (if not already defaulted). The software and printer will draw a FIM E mark and/or unique POSTNET barcode and/or PLANETNET code and “Void” on the indicia 114. Last, the voided sample will be printed in step 116. If the user wishes to print postage for an actual mail piece, the user will select the SELECT “PRINT POSTAGE” 118, and then select the paper feed 120 (if not already defaulted). The software and printer will then draw a valid indicia and FIM A˜C mark, and a valid POSTNET barcode and/or a valid PLANETNET code in step 122. Lastly, a valid indicia and selected FIM A˜C mark will be printed on the mail piece.

While the invention is discussed with reference to envelopes, the invention is applicable to all types of mail pieces to which a FIM pattern can be applied, or where a sender address label is generated.

The drawings and the foregoing description are not intended to represent the only form of the invention in regard to the details of this construction and manner of operation. In fact, it will be evident to one skilled in the art that modifications and variations may be made without departing from the spirit and scope of the invention. Although specific terms have been employed, they are intended in a generic and descriptive sense only and not for the purpose of limitation.

What is claimed is:

1. A postage indicium fraud detection method for permitting the automated processing of void mail pieces bearing a unique indicium, comprising:
printing a first unique indicium on a mail piece or a label to be applied to a mail piece, which first unique indicium is adapted to be identified and sorted by automated mail handling equipment and which unique indicium identifies the mail piece as being a void mail piece.

2. The postage indicium fraud detection method of claim 1, wherein the first unique indicium comprises a unique facing identification making (FIM) different from FIM A, FIM B, and FIM C, which uniquely identifies the mail piece as being a void mail piece, and which unique facing identification marking is used by automated mail handling equipment to segregate void mail pieces bearing the unique facing identification marking from mail pieces not bearing the unique facing identification marking.

3. The postage indicium fraud detection method of claim 1, wherein the first unique indicium comprises a unique postal numeric encoding technique barcode which is used by automated mail handling equipment to segregate void mail pieces bearing the unique postage numeric encoding technique barcode from mail pieces not bearing the unique postage numeric encoding technique barcode.

4. The postage indicium fraud detection method of claim 1, wherein an additional indicium comprising a unique postal alpha numeric encoding technology barcode is printed onto the mail piece or label for the mail piece, which unique postal alpha numeric encoding technology barcode is used to at least one of identify the sender of the void mail piece, the time of the void mail handling, and collect statistics on attempts to mail void mail pieces by the sender.

5. A postage indicium fraud detection method for permitting the automated processing of void mail pieces bearing a first unique indicium using existing automated mail handling equipment, comprising:
printing a first unique indicium on a mail piece or a label to be applied to a mail piece, which first unique indicium is adapted to be identified and sorted by automated mail handling equipment and which unique indicium identifies the mail piece as being a void mail piece; and
processing the void mail piece bearing the first unique indicium with the automated mail handling equipment to identify and segregate the void mail piece from other non-void mail pieces.

6. The postage indicium fraud detection method of claim 5, wherein the first unique indicium comprises a unique facing identification marking different from facing identification markings (FIM) FIM A, FIM B, and FIM C.

7. The postage indicium fraud detection method of claim 5, wherein the first unique indicium comprises a unique postal numeric encoding technique barcode which is used by automated mail handling equipment to segregate void mail pieces bearing the unique postal numeric encoding technique barcode from mail pieces not bearing the unique postal numeric encoding technique barcode.

8. The postage indicium fraud detection method of claim 5, further comprising printing a second unique indicia, comprising a postal alpha numeric encoding technology barcode which is used by automated mail handling equipment to identify the sender of the void mail piece, the time of the void mail handling, and collect statistics on attempts to mail void mail pieces by the sender.

9. A postage indicium fraud detection method for permitting the automated processing and segregation of void mail pieces bearing a first unique indicium from non-void mail pieces not bearing the first unique indicium, comprising:
providing client software which permits a user to print information based indicia postage onto a mail piece or label for a mail piece;
having the user enter a valid delivery address, select a type of mail piece, mail class, attributes, and special services;
having the user verify and accept the address and any modifications thereto;
having the user select between printing a sample void information based indicia postage and a non-void information based postage indicia;
having a user print a sample information based postage indicia for void mail pieces and printing non-void information based postage indicia for non-void mail pieces; and
providing automated mail handling equipment which is adapted to segregate void information based postage indicia bearing mail pieces from non-void information based postage indicia bearing mail pieces.

10. The postage indicium fraud detection method of claim 9, further comprising printing a unique postal alpha numeric encoding technology barcode onto the mail piece or label therefor which is used by automated mail handling equipment to at least one of identify the sender of the void mail piece, the time of the void mail handling, and collect statistics on attempts to mail void mail pieces by the sender.

11. A postage indicium fraud detection method for permitting the automated processing, identification, and segregation of void mail pieces bearing a first unique indicium, comprising:
providing automated mail handling equipment which is adapted to sort mail based on indicia placed on mail pieces; and
providing client software for printing a first unique indicium on a mail piece or a label to be applied to a mail piece, which first unique indicium is adapted to be identified and sorted by automated mail handling equipment and which first unique indicium identifies the mail piece as being a void mail piece.

12. The postage indicium fraud detection method of claim 11, wherein the client software is adapted to generate a unique postal alpha numeric encoding technology barcode, which when printed on a mail piece or label therefor is used by automated mail handling equipment to at least one of identify the sender of the void mail piece, the time of the void mail handling, and collect statistics on attempts to mail void mail pieces by the sender.
